(19) United States
(12) Patent Application Publication
(10) Pub. No.: US 2013/0250260 A1
(43) Pub. Date: Sep. 26, 2013

(54) PELLICLES FOR USE DURING EUV PHOTOLITHOGRAPHY PROCESSES

(71) Applicant: MANDEEP SINGH, LN DELFT (NL)

(72) Inventor: MANDEEP SINGH, LN DELFT (NL)

(73) Assignee: GLOBALFOUNDRIES INC., Grand Cayman (KY)

(21) Appl. No.: 13/428,475

(22) Filed: Mar. 23, 2012

(51) Int. Cl. G03B 27/42

(52) U.S. Cl. 355/53; 355/77

(57) ABSTRACT

Disclosed herein are various pellicles for use during extreme ultraviolet (EUV) photolithography processes. An EUV radiation device disclosed herein includes a reticle, a substrate support stage, a pellicle positioned between the reticle and the substrate support stage, wherein the pellicle is comprised of multiple layers of at least one single atomic-plane material, and a radiation source that is adapted to generate radiation at a wavelength of about 20 nm or less that is to be directed through the pellicle toward the reticle.

### BACKGROUND OF THE INVENTION

1. Field of the Invention

Generally, the present disclosure relates to the manufacture of sophisticated semiconductor devices, and, more specifically, to various pellicles for use during extreme ultraviolet (EUV) photolithography processes.

2. Description of the Related Art

The fabrication of advanced integrated circuits, such as CPU's, storage devices, ASIC's (application specific integrated circuits) and the like, requires the formation of a large number of circuit elements in a given chip area according to a specified circuit layout, wherein field effect transistors (NMOS and PMOS transistors) represent one important type of circuit element used in manufacturing such integrated circuit devices. In general, integrated circuit devices are formed by performing a number of process operations in a detailed sequence or process flow. Such process operations typically include deposition, etching, ion implantation, photolithography and heating processes that are performed in a very detailed sequence to produce the final device. Device designers are under constant pressure to increase the operating speed and electrical performance of transistors and integrated circuit products that employ such transistors. One technique that continues to be employed to achieve such results is the reduction in size of the various devices, such as the gate length of the transistors. The gate length (the distance between the source and drain regions) on modern transistor devices may be approximately 30-50 nm, and further down-ward scaling is anticipated in the future. Manufacturing devices that are so small is a very difficult challenge, particularly for some processes, such as photolithography tools and techniques.

Known photolithography tools include so-called steppers, in which each target portion is irradiated by exposing an entire pattern onto the target portion at one time, and so-called scanners, in which each target portion is irradiated by scanning the pattern through a radiation beam in a given direction (the “scanning” direction) while synchronously scanning the substrate parallel or anti-parallel to this direction. It is also possible to transfer the pattern from the patterning device to the substrate by imprinting the pattern onto the substrate.

Photolithography tools and systems typically include a source of radiation at a desired wavelength, an optical system and, typically, the use of a so-called mask or reticle that contains a pattern that is desired to be formed on a wafer. Radiation is provided through or reflected off the mask or reticle to form an image on a semiconductor wafer. The radiation used in such systems can be light, such as ultraviolet light, deep ultraviolet light (DUV), vacuum ultraviolet light (VUV), extreme ultraviolet light (EUV), etc. The radiation can also be x-ray radiation, e-beam radiation, etc. Generally, the image on the reticle is utilized to irradiate a light-sensitive layer of material, such as photoresist material. Ultimately, the irradiated layer of photoresist material is developed to define a patterned mask layer using known techniques. Ultimately, the patterned mask layer can be utilized to define doping regions, deposition regions, etching regions or other structures associated with an integrated circuit. Currently, most of the photolithography systems employed are so-called deep ultraviolet systems (DUV) that generate radiation at a wavelength of 248 nm or 193 nm. However, the capabilities and limits of traditional DUV photolithography systems are being tested as device dimensions continue to shrink. This has led to the development of a so-called EUV system that uses radiation with a wavelength less than 20 nm, e.g., 13.5 nm.

Reducing particle contamination in photolithography processes, particularly on the reticle, has always been an ongoing task. The presence of even very minute particles during the photolithography process may lead to the patterning of inaccurate or undesirable features on a wafer, and may lead to the formation of devices with reduced performance capabilities. In many cases, the presence of undesirable particles during photolithography processes may render the resulting devices inoperable. For that reason, semiconductor manufacturers go to great lengths and great expense to keep the photolithography processes they employ as clean as possible. This involves very detailed and expensive handling and cleaning procedures for all of the components of a photolithography system, including the reticles. The cleanliness requirement for photolithography processes is only going to increase as EUV systems are adopted because the EUV systems are sensitive to contamination by extremely small particles that might not create a problem for DUV systems. In addition, other non-particulate forms of contamination, e.g., organic and inorganic chemical contaminants, even at the level of a few atomic layers, must be prevented from adhering to critical surfaces.

Most modern photolithography tools include a pellicle that is positioned between the reticle and the wafer. Generally, conventional DUV photolithography systems which utilize wavelengths of 193 nm or more include the pellicle to seal off the mask or reticle to protect it from airborne particles and other forms of contamination. Contamination on the surface of the reticle or mask can cause manufacturing defects on the wafer. For example, pellicles are typically used to reduce the likelihood that particles might migrate into a stepping field of a reticle in a stepping lithographic system, i.e., into the object plane of the imaging system. If the reticle or mask is left unprotected, the contamination can require the mask or reticle to be cleaned or discarded. Cleaning the reticle or mask interrupts valuable manufacturing time and discarding the reticle or mask is costly. Replacing the reticle or mask also interrupts valuable manufacturing time.

A pellicle is typically comprised of a pellicle frame and a membrane. The pellicle frame may be comprised of one or more walls which are securely attached to the absorber (chrome) side of the mask or reticle. Pellicles have also been employed with anti-reflective coatings on the membrane material. The membrane is stretched across the metal frame and prevents any contaminants from reaching the mask or reticle. The membrane is preferably thin enough to avoid the introduction of aberrations and to be optically transparent and yet strong enough to be stretched across the frame. The optical transmission losses associated with the membrane of the pellicle can affect the exposure time and throughput of the photolithography system. The optical transmission losses are due to reflection, absorption and scattering. Stretching the membrane ensures that it is flat and does not adversely affect the image projected onto the wafer. The membrane of the pellicle generally covers the entire printable area of a mask or reticle and is sufficiently durable to withstand cleaning and handling.

Pellicles for EUV systems should be stable enough to retain their shape over long periods of time and many exposures to flashes of radiation and be tolerant of repeated maintenance procedures. Small particles that adhere to the pellicle surface (the membrane) generally do not significantly obstruct light directed to the surface of the wafer. The metal frame ensures that a minimum stand-off distance from the mask is provided to ensure that no more than about a 10% reduction in light intensity on the wafer surface is achieved for a particle of a particular size. The pellicle also keeps any optical signatures due to particles out of the depth of field of the lens. Thus, the stand-off distance prevents contaminants from being imaged onto the wafer since the depth-of-field of the imaging lens is orders of magnitude smaller than the pellicle-mask stand-off distance.

Conventional materials used as a pellicle for EUV lithographic systems include thin metallic or ceramic films stretched and mounted over the reticle. Such films have usually consisted of silicon or molybdenum membranes. To avoid a huge loss of light throughput due to material absorption, these membranes typically have a maximum thickness in the range of about 50-100 nm. These membranes typically cover a relatively large area of about 100-200 cm². At such small thicknesses, these membranes are prone to destruction due to mechanical loading (from mounting and vibrations) and thermo-mechanical loading due to heat-induced stress. The heating effect is a direct result of the intrinsically high absorption of all substances in the EUV spectral region of interest (around 13.5 nm). Furthermore, the thermal loading at incident optical powers approaching several watts of in-band EUV power (likely needed for high volume manufacturing) can severely deform and even melt the membranes. Some attempts to counteract these mechanical shortcomings have been made by mounting the membranes on a rigid wire mesh. See, e.g., Schroff et. al., “High transmission pellicles for extreme ultraviolet lithography reticle protection,” J. Vac. Sci. Technol., B28, C6E36 (2010). However, such a solution has proven to be unworkable, probably due to the high light loss and light scattering as a result of the wire mesh backbone of the membrane. Such an approach has been largely abandoned.

There is a need for a pellicle to be used in EUV applications that is more durable or stable than conventional pellicle materials. The present invention is directed to several different embodiments of such a pellicle.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the present disclosure is directed to various pellicles for use during extreme ultraviolet (EUV) photolithography processes. In one example, an EUV radiation device disclosed herein includes a reticle, a substrate support stage, a pellicle positioned between the reticle and the substrate support stage, wherein the pellicle is comprised of multiple layers of at least one single atomic-plane material, and a radiation source that is adapted to generate radiation at a wavelength of about 20 nm or less that is to be directed through the pellicle toward the reticle.

In another example, an EUV radiation device disclosed herein includes a reticle, a substrate support stage, a pellicle positioned between the reticle and the substrate support stage, wherein the pellicle is comprised of multiple layers of at least one of graphene or hexagonal boron nitride, and a radiation source that is adapted to generate radiation at a wavelength of about 20 nm or less that is to be directed through the pellicle toward the reticle.

In another illustrative example, a method disclosed herein includes positioning a pellicle between a reticle and a semiconducting substrate, wherein the pellicle is comprised of multiple layers of at least one single atomic-plane material, generating radiation at a wavelength of about 20 nm or less and directing the generated radiation through the pellicle toward the reticle such that a significantly large portion of the generated radiation reflects off of the reticle back through the pellicle toward the wafer.

In yet another illustrative example, a method disclosed herein includes positioning a pellicle between a reticle and a semiconducting substrate, wherein the pellicle is comprised of multiple layers of at least one of graphene or hexagonal boron nitride, generating radiation at a wavelength of about 20 nm or less and directing the generated radiation through the pellicle toward the reticle such that a significantly large portion of the generated radiation reflects off of the reticle back through the pellicle toward the wafer.

### BRIEF DESCRIPTION OF THE DRAWINGS

The disclosure may be understood by reference to the following description taken in conjunction with the accompanying drawings, in which like reference numerals identify like elements, and in which:

FIGS. 1A-1K depict various illustrative embodiments of the novel pellicles and reticles disclosed herein; and

FIGS. 2A-2B are schematic depictions of an illustrative photolithography system wherein the pellicles disclosed herein may be employed.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

The present disclosure is directed to various pellicles for use during extreme ultraviolet (EUV) photolithography processes. As will be readily apparent to those skilled in the art upon a complete reading of the present application, the pellicles disclosed herein may be employed in the fabrication of a variety of devices, including, but not limited to, semiconductor devices, such as logic devices, memory devices, nano-optical devices, etc. With reference to the attached figures, various illustrative embodiments of the devices disclosed herein will now be described in more detail.

At a very high level, the pellicles disclosed herein are comprised of multiple layers of material that exhibit a single atomic-plane hexagonal mesh-type atomic structure, which will henceforth be referred to in this detailed description and in the appended claims as “single atomic-plane” material. Examples of single atomic-plane materials are graphene (hereinafter “Gr” or “graphene”), single atomic layer hexagonal boron nitride (hereinafter “h-BN”), molybdenum sulphide (MoS₂), molybdenum selenide (MoSe₂), molybdenum telluride (MoTe₂), tungsten sulphide (WS₂), tantalum selenide (TaSe₂), niobium selenide (NbSe₂), nickel telluride (NiTe₂), bismuth telluride (Bi₂Te₃) and the like. At a very high level, one aspect of the inventions disclosed herein involves pellicles that are comprised of multiple layers of single atomic-plane material. In some cases, the multiple layers of single atomic-plane material may all be of the same material, e.g., multiple layers of graphene only, or multiple layers of single atomic layer hexagonal boron nitride only. In other cases, the multiple layers of single atomic-plane material may be a combination of a plurality of any of the single atomic-plane materials identified above, and they may be arranged in any of a variety of different combinations and arrangements.

In some applications, the pellicles disclosed herein may also include one or more layers of a relatively thin, low-absorptive material that is positioned between opposing layers of single atomic-plane material. e.g., between graphene and/or h-BN. After a complete reading of the present application, those skilled in the art will appreciate that the pellicles disclosed herein may have a variety of different configurations in terms of the number of layers of single atomic-plane material, the relative position of such layers of single atomic-plane material and the location of any layers of the aforementioned low-absorptive material. Thus, the inventions disclosed herein should not be considered as limited to any of the illustrative embodiments disclosed herein.

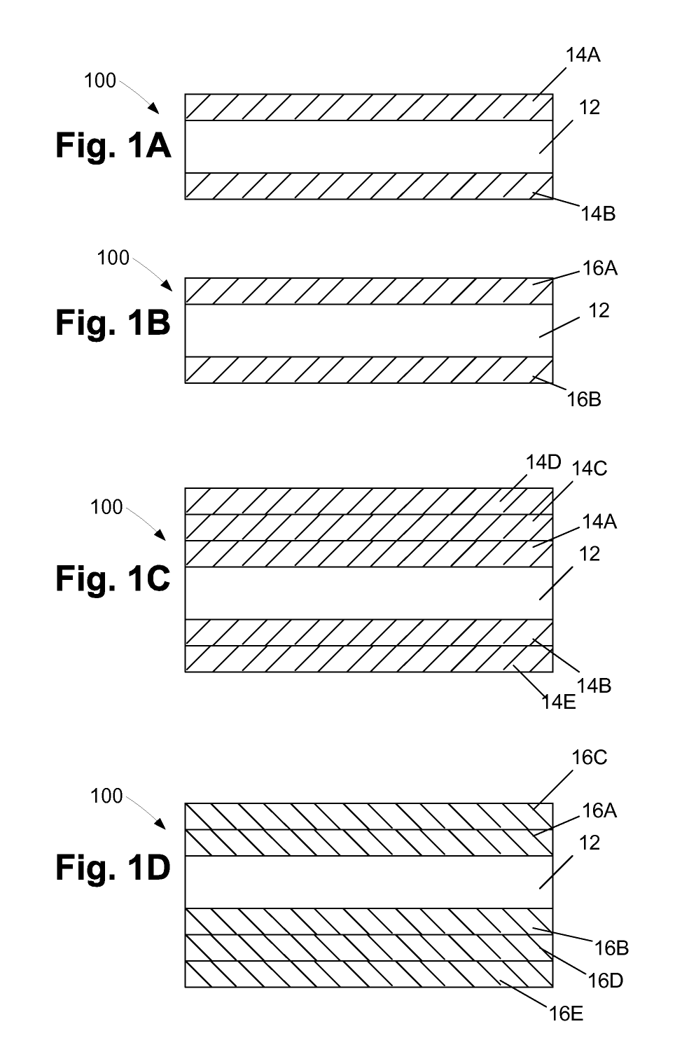

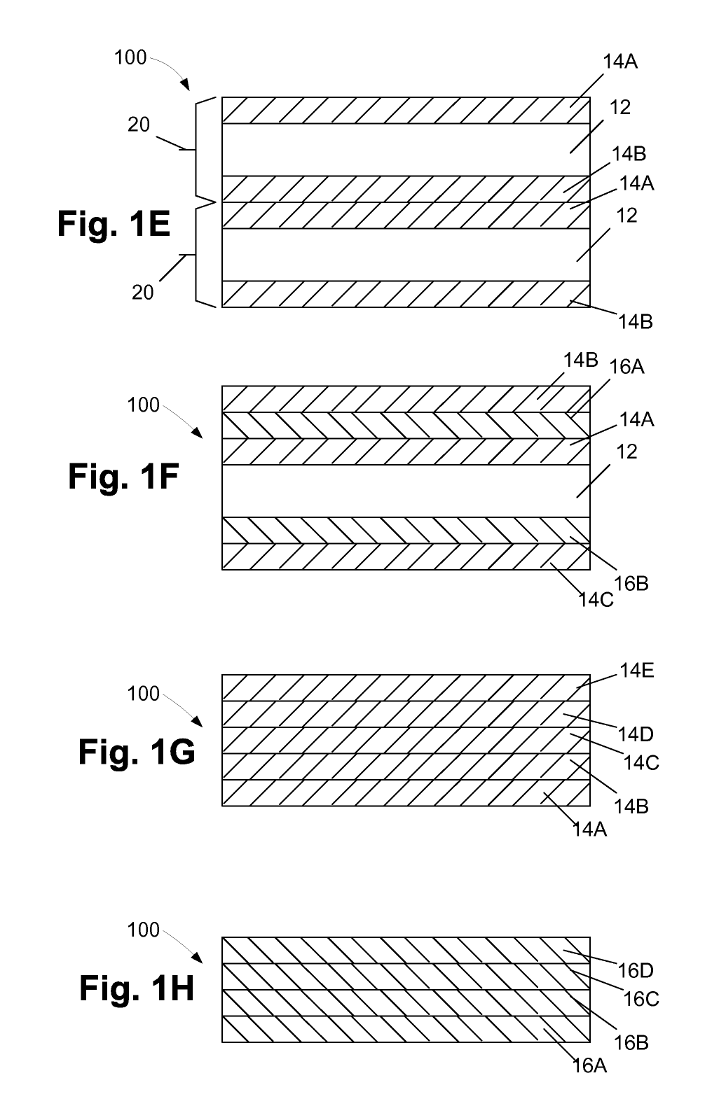

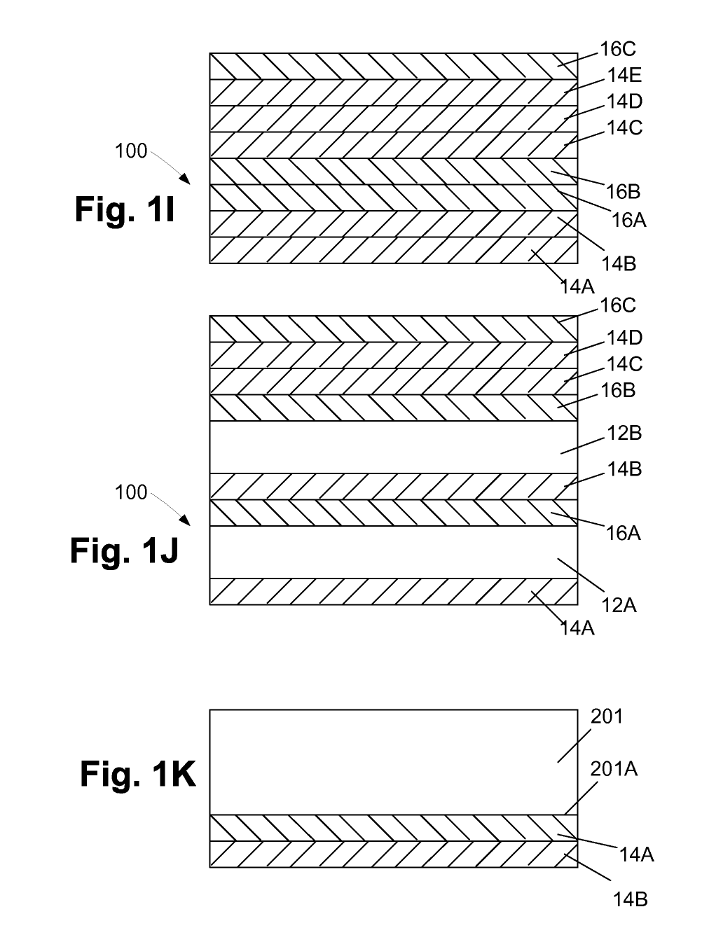

FIG. 1A is a simplified view of one illustrative embodiment of a pellicle 100 disclosed herein. For purposes of disclosing the various inventions herein, the discussion will be directed to the use of two illustrative single atomic-plane materials: graphene and h-BN. However, as will be recognized by those skilled in the art after a complete reading of the present application, the inventions disclosed herein may be employed using a variety of different single atomic-plane materials. Thus, the present inventions should not be considered as limited to any particular type of single atomic-plane material unless a specific single atomic-plane material is specified in the appended claims. In this illustrative embodiment, the pellicle 100 is comprised of a low-absorption material layer 12 and layers of graphene 14A, 14B positioned on opposite sides of the low-absorption material layer 12. FIG. 1B is a simplified view of another illustrative embodiment of a pellicle 100 disclosed herein, wherein layers of h-BN 16A, 16B are positioned on opposite sides of the low-absorption material layer 12. Although not depicted in any of the attached figures, another embodiment of a pellicle disclosed herein would be like that depicted in FIG. 1A except that a layer of h-BN, may be substituted for the layer of graphene 14B. In some embodiments, the total number of the layers of single atomic-plane material, e.g., graphene and the layers of h-BN, used on any particular pellicle may be limited when the undesirable absorption of incident EUV radiation on the pellicle approaches or exceeds acceptable limits. For example, in one illustrative embodiment, where the pellicles 100 are intended for use in photolithography systems using EUV radiation at a wavelength of about 13.5, the total number of such layers of single atomic-plane material in a single pellicle may be limited to about 10 layers. The physical size and shape of the pellicles disclosed herein may vary depending upon the particular application and the photolithography system employed, e.g., the pellicles may have a configuration that is circular, rectangular, square, etc. In one particularly illustrative example, the pellicles 100 disclosed herein may have a generally 6″×6″ square configuration. The overall thickness of the pellicle 100 may vary depending upon the particular application. In one illustrative embodiment, the overall thickness of the pellicle 100 may fall within the range of about 0.3-20 nm, depending upon its composition and construction.

In one illustrative embodiment, the low-absorption material layer 12 may be comprised of a variety of materials such as, for example, silicon (Si), silicon-carbon (SiC), beryllium (Be), boron-carbide (B₄C), lanthanum (La), silicon nitride (Si₃N₄), molybdenum (Mo), ruthenium (Ru), niobium (Nb), carbon nanotubes (CNT), synthetic diamond and diamond-like carbon, etc., and it may have a thickness that falls within the range of about 5-50 nm. In one illustrative embodiment, the low-absorption material layer 12 may have a extinction coefficient in the EUV spectral region of about 6-20 nm that is less than about 0.02, and in other embodiments less than 0.002. In general, in one example, the low-absorption material layer 12 may be a silicon wafer that is made or thinned to the desired final thickness. In another example, the low-absorption material layer 12 may be formed by depositing that appropriate material on a sacrificial structure, such as a polymer, and thereafter removing the sacrificial structure by performing a selective etching or dissolution process, thereby leaving the low-absorption material layer 12.

The illustrative layers of graphene disclosed herein, which are generally referred to with the reference number 14, may be manufactured using a variety of known techniques. For example, in one illustrative embodiment, the layers of graphene disclosed herein may be manufactured using a roll-to-roll manufacturing technique that is generally disclosed in a paper entitled “Roll-to roll production of 30-inch graphene films for transparent electrodes,” Bae et al., Nature Nanotechnology, 5:574 (2010), which is hereby incorporated by reference in its entirety. In general, this process involves performing a chemical vapor deposition (CVD) process to deposit a layer of graphene on a copper film, attaching a polymer material layer to the layer of grapheme, performing a selective etching process to remove the copper film relative to the graphene and the polymer material, and removing the polymer material layer from the layer of graphene. The layer of graphene may then be attached to any desired target, such as a silicon substrate. The layers of graphene referenced herein may also be chemically derived graphene manufactured by the technique described in an article entitled “Highly Uniform 300 mm Wafer-Scale Deposition of Single and Multilayered Chemically Derived Graphene Thin Films,” Yamaguchi et al., ACS Nano, 4:524 (2010), which is hereby incorporated by reference in its entirety. Thus, the manner in which the layers of graphene discussed herein are manufactured should not be considered as a limitation of the inventions disclosed herein.

The illustrative layers of h-BN disclosed herein, which are generally referred to with the reference number 16, may be manufactured using a variety of known techniques. For example, in one illustrative embodiment, the layers of h-BN disclosed herein may be manufactured using a technique that is generally disclosed in a paper entitled “Large Scale Growth and Characterization of Atomic Hexagonal Boron Nitride Layers,”, Song et al., Nano Letters, (2010), which is hereby incorporated by reference in its entirety. In general, the process described in this paper involves performing a thermal catalytic chemical vapor deposition (CVD) process to deposit h-BN material (2-5 layers thick) on a copper film in a furnace that is at a temperature of about 1000° C. After the h-BN material is formed, the h-BN material was coated with a polymer and transferred to another substrate. Thus, the manner in which the layers of h-BN discussed herein are manufactured should not be considered as a limitation of the inventions disclosed herein.

In the examples disclosed herein, each of the layers of graphene, e.g., layer 14A, and each of the layers of h-BN, e.g., layer 16A, are depicted as single layers of such material. That is, the layer 14A depicts a layer of graphene that has a thickness of one atomic layer of graphene, while the layer 16A depicts a layer of h-BN that has a thickness of one atomic layer of h-BN. In some cases, the single layers of graphene and/or h-BN may be formed one at a time by repeating a single process a desired number of times, or multiple layers of such material may be formed in a single process operation. In general, the layers of graphene and h-BN may have a thickness of about 0.3-3 nm, e.g., from a single atomic-layer to about 10 or more atomic-layers that are in a stacked configuration

Various other illustrative embodiments of the pellicles 100 disclosed herein will now be described. FIG. 1C depicts an illustrative example wherein the pellicle 100 is comprised of the low-absorption material layer 12 and five layers of graphene (14A-14E). In this embodiment, three layers of graphene (14A, 14C and 14D) are positioned above the low-absorption material layer 12 while two layers of graphene (14B, 14E) are formed below the low-absorption material layer 12. FIG. 1D depicts another illustrative example of a pellicle 100 that is comprised of the low-absorption material layer 12 and five layers of h-BN (16A-16E). In this embodiment, two layers of h-BN (16A and 16C) are positioned above the low-absorption material layer 12 while the three layers of h-BN (16B, 16D and 16E) are formed below the low-absorption material layer 12. Of course the use of the letter designations (e.g., A-E) for the layers of graphene 14 and the h-BN layers 16 in all of the various embodiments disclosed herein should not be understood to imply any particular order of manufacture or arrangement. The graphene and/or h-BN layers may also be symmetrically positioned about the low-absorption material layer 12, e.g., 2-10 layers on each side of the low-absorption material layer 12.

FIG. 1E depicts an illustrative pellicle 100 that is comprised of multiple stacks 20 of multi-layered structures. In the depicted example, each of the stacks 20 is comprised of the low-absorption material layer 12 and two layers of graphene (14A-14B) that are positioned on opposite sides of the low-absorption material layer 12. The final pellicle may be comprised of any desired number of the stacks 20. Of course, as will be recognized by those skilled in the art after a complete reading of the present application, a layer of h-BN 16 could be substituted for any or all of the layers of graphene 14 depicted in FIG. 1E. Moreover, layers of h-BN could be interleaved between successive graphene layers if desired.

FIG. 1F depicts an illustrative example of a pellicle 100 that is comprised of mixed layers of graphene 14 and h-BN 16. More specifically, in this illustrative embodiment, the pellicle is comprised of three layers of graphene (14A, 14B and 14C) and two layers of h-BN 16 (16A, 16B). In this example, the layer of h-BN 16A is sandwiched between the layers of graphene 14A, 14C. Also in this example, the layer of graphene 14A contacts the upper surface of the low-absorption material layer 12, while the layer of h-BN 16B contacts the lower surface of the low-absorption material layer 12.

In the examples described up to this point, the pellicles 100 have been comprised of at least one of the of low-absorption material layers 12. However, the low-absorption material layer 12 may not be employed in all of the embodiments disclosed herein. For example, FIG. 1G depicts an illustrative pellicle that is comprised of five layers of graphene (14A-14E). FIG. 1H depicts an illustrative example of a pellicle 100 that is comprised of four layers of hBN (16A-16D) stacked together. FIG. 1I depicts an illustrative pellicle 100 that is comprised of a stacked arrangement of eight layers—five layers of graphene (14A-14E) and three layers of h-BN (16A-16C). With respect to the pellicle depicted in FIG. 1I, as noted earlier with respect to a previous embodiment of a pellicle 100 disclosed herein, the number of the various layers of graphene 14 and h-BN 16 for the pellicle 100 shown in FIG. 1I may be different depending upon the particular application. Typically, in some applications, the number of layers may vary from about one to 20 layers. However, as noted previously, the present invention should not be considered as limited to the use of any particular number of layers of single atomic-plane material, e.g., graphene and/or h-BN.

As yet another example, FIG. 1J depicts an illustrative pellicle 100 that is comprised of two low-absorption material layers 12A, 12B, four layers of graphene (14A-14D) and three layers of h-BN (16A-16C). In this example, two layers of graphene (14C, 14D) are sandwiched between layers of h-BN (16B, 16C). From the foregoing illustrative example, it should be clear to one skilled in the art having benefit of the present disclosure that the pellicles 100 may be comprised of a variety of arrangements of the different single atomic-plane materials disclosed herein.

FIG. 1K depicts another embodiment of a device disclosed herein. In this embodiment, one or more layers of an electrically conductive single atomic-plane material are applied to the rear surface 201A of a generic EUV reticle 201. The number of layers of single atomic-plane material that may be employed may vary depending upon the particular application, e.g., in some cases, 1-10 layers of single atomic-plane material may be positioned below the bottom surface 201A of the EUV reticle 201. In the depicted example, two layers of single atomic-plane material are positioned below the bottom surface 201A, i.e., two layers of graphene 14A, 14B. The EUV reticle 201 is intended to be representative of any type of EUV reticle that is used in EUV lithography tools and systems. In general, EUV reticles are typically clamped in an electrostatic chuck within a lithography tool. The backside of such EUV reticles is typically coated with an electrically conductive layer, such as a 10-100 nm thick transition-metal-containing material like chromium nitride (CrN). Such conductive films tend to be vacuum deposited on the rear surface of the reticle. However, these type of conductive films may be prone to damage by the burls of the electrostatic chuck, whereby nano-particulates may be shed, leading to possible contamination of the system and to the generation of defects on the manufactured devices. It is believed that the strong covalent bonding of the single atomic-layer materials identified above, e.g., graphene, and the lack of amorphous/microcrystalline formations in the membrane (unlike in the case of vacuum-deposited films like CrN), may be significantly less prone to damage, e.g., perforation or chipping. Thus, by forming the conductive material on the backside of the reticle 201 from one or more layers of an electrically conductive single atomic-layer material, EUV lithography processes may become more effective and efficient.

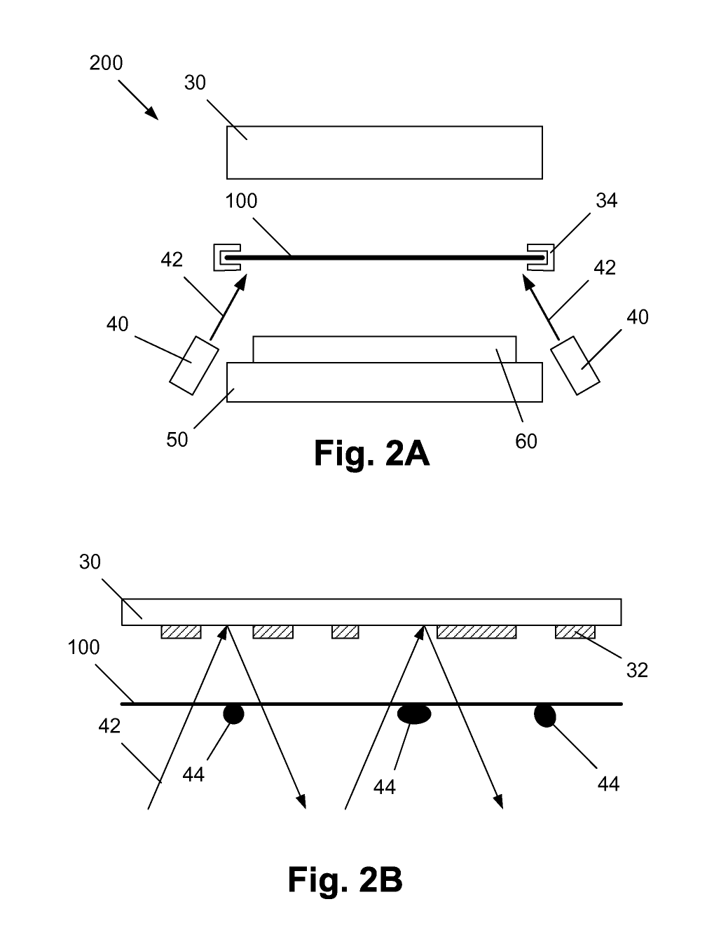

Use of the pellicles 100 disclosed herein will be further described with reference to FIGS. 2A-2B. FIG. 2A is a schematic depiction of an illustrative photolithography system or tool 200 where the pellicles 100 may be employed, while FIG. 2B in an enlarged view of a portion of the photolithography system or tool 200. As shown in FIG. 2A, the photolithography system or tool 200 is generally comprised of a photomask or reticle 30, a substrate or wafer support stage 50, a source of EUV radiation 40 and a pellicle 100. The pellicle 100 is secured within a photolithography system or tool 200 by illustrative and schematically depicted clamps 34, which may be of any of a variety of different mechanical structures and they are typically positioned on or adjacent the reticle frame. The EUV radiation source 40 is adapted to generate EUV radiation 42 that is to be directed through the pellicle 100 toward the reticle 30. The photolithography system or tool 200 may comprise multiple mirrors or lenses (not shown) for directing the EUV radiation 42 as desired. An illustrative silicon wafer 60, comprised of multiple die (not shown) where integrated circuit devices are being formed is positioned on the wafer stage 50. Of course, as will be appreciated by those skilled in the art, the schematic depiction of the photolithography system or tool 200 is simplistic in nature and it does not depict all aspects of a real-world EUV photolithography system or tool. Nevertheless, with benefit of the present disclosure, one skilled in the art will be able to employ the pellicles 100 disclosed herein on such EUV tools and systems.

As depicted in FIG. 2B, the reticle 30 is comprised of features 32 that are to be transferred to the underlying wafer 60 using EUV photolithography techniques. The reticle 30 is reflective and it is comprised of a multi-layer thin film reflector that is tuned to reflect a significant portion of the EUV radiation, i.e., an amount of EUV radiation sufficient to perform the desired photolithographic processes. The reticle 30 is comprised of a multi-layer thin film reflector that is tuned to reflect EUV radiation of a given wavelength, e.g., 13.5 nm, the central wavelength of all the reflective surfaces of the optical system comprising the collector, illuminator and the projection optics. As noted above, a significant portion of the EUV radiation 42 is reflected off of the reticle 30 and, accordingly, passes through the pellicle 100 twice, as depicted in FIG. 2B. In general, the pellicle 100 is positioned between the reticle 30 and the wafer 60 in an effort to prevent particles 44 from landing on the reticle 30 during the photolithography process. The pellicle 100 is not positioned in the object plane of the photolithography system or tool 200 so that images corresponding to the particles 44 that land on the pellicle 100 are not printed on the wafer 60. In one illustrative embodiment, the pellicle 100 may be placed a distance of about 2-10 mm below the reticle 30, although that distance may vary depending upon the particular application and the particular details of construction of the photolithography system or tool 200.

The pellicles 100 disclosed herein may be used to protect the reticle 30 in the photolithography system or tool 200 from particle contamination as described above. The pellicle 100 may be removed and cleaned or discarded in accordance with a desired maintenance plan, e.g., after a set number of wafers have been processed through the photolithography system or tool 200. Since single atomic-plane materials disclosed herein, such as graphene and h-BN, tend to have relatively high tensile strength (about 130 GPa for graphene), the pellicles 100 disclosed herein are robust and durable devices that can be repeatedly cleaned and reused, thereby reducing the cost associated with EUV photolithography processing.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. An EUV radiation device, comprising:
a reticle;
a substrate support stage;
a pellicle positioned between said reticle and said substrate support stage, wherein said pellicle is comprised of multiple layers of at least one single atomic-plane material; and
a radiation source that is adapted to generate radiation at a wavelength of about 20 nm or less that is to be directed through said pellicle toward said reticle.

2. The device of claim 1, wherein said pellicle further comprises a low-absorption layer of material having an extinction coefficient of at most about 0.02 in the EUV spectral region of about 6-20 nm, wherein at least one of said multiple layers of single atomic-plane material is formed on said low-absorption layer of material.

3. The device of claim 1, wherein said at least one single atomic-plane material is comprised of at least one of graphene, hexagonal boron nitride, molybdenum sulphide (MoS₂), molybdenum selenide (MoSe₂), molybdenum telluride (MoTe₂), tungsten sulphide (WS₂), tantalum selenide (TaSe₂), niobium selenide (NbSe₂), nickel telluride (NiTe₂), and bismuth telluride (Bi₂Te₃).

4. The device of claim 1, wherein said pellicle is comprised of only multiple layers of graphene.

5. The device of claim 1, wherein said pellicle is comprised of only multiple layers of hexagonal boron nitride.

6. The device of claim 1, wherein said pellicle is comprised of multiple layers of graphene and multiple layers of hexagonal boron nitride.

7. The device of claim 1, wherein said pellicle is comprised of multiple layers of materials selected from the following materials: graphene, hexagonal boron nitride, molybdenum sulphide (MoS₂), molybdenum selenide (MoSe₂), molybdenum telluride (MoTe₂), tungsten sulphide (WS₂), tantalum selenide (TaSe₂), niobium selenide (NbSe₂), nickel telluride (NiTe₂), and bismuth telluride (Bi₂Te₃).

8. The device of claim 1, wherein said pellicle is comprised of a low-absorption layer of material having an extinction coefficient of at most about 0.02 in the EUV spectral region of about 6-20 nm and multiple layers of single atomic-plane material, wherein at least first and second layers of said multiple layers of single atomic-plane material are positioned on opposite sides of said low-absorption layer of material.

9. The device of claim 1, wherein said pellicle is comprised of a low-absorption layer of material having an extinction coefficient of at most about 0.02 in the EUV spectral region of about 6-20 nm, said low-absorption layer of material being positioned between multiple layers of a first single atomic-plane material and multiple layers of a second single atomic-plane material.

10. An EUV radiation device, comprising:
a reticle;
a substrate support stage;
a pellicle positioned between said reticle and said substrate support stage, wherein said pellicle is comprised of multiple layers of at least one of graphene or hexagonal boron nitride; and
a radiation source that is adapted to generate radiation at a wavelength of about 20 nm or less that is to be directed through said pellicle toward said reticle.

11. The device of claim 10, wherein said pellicle further comprises a low-absorption layer of material having an extinction coefficient of at most about 0.02 in the EUV spectral region of about 6-20 nm, wherein at least one of said multiple layers is formed on said low-absorption layer of material.

12. The device of claim 10, wherein said pellicle is comprised of only multiple layers of graphene.

13. The device of claim 10, wherein said pellicle is comprised of only multiple layers of hexagonal boron nitride.

14. The device of claim 10, wherein said pellicle is comprised of multiple layers of graphene and multiple layers of hexagonal boron nitride.

15. The device of claim 10, wherein said pellicle is comprised of a low-absorption layer of material having an extinction coefficient of at most about 0.02 in the EUV spectral region of about 6-20 nm and multiple layers of graphene, wherein at least first and second layers of said multiple layers of graphene are positioned on opposite sides of said low-absorption layer of material.

16. The device of claim 10, wherein said pellicle is comprised of a low-absorption layer of material having an extinction coefficient of at most about 0.02 in the EUV spectral region of about 6-20 nm and multiple layers of hexagonal boron nitride, wherein at least first and second layers of said multiple layers of hexagonal boron nitride are positioned on opposite sides of said low-absorption layer of material.

17. The device of claim 10, wherein said pellicle is comprised of a low-absorption layer of material having an extinction coefficient of at most about 0.02 in the EUV spectral region of about 6-20 nm, said low-absorption layer of material being positioned between multiple layers of graphene and multiple layers of hexagonal boron nitride.

18. A method, comprising:
positioning a pellicle between a reticle and a semiconducting substrate, wherein said pellicle is comprised of multiple layers of at least one single atomic-plane material;
generating radiation at a wavelength of about 20 nm or less; and
directing said generated radiation through said pellicle toward said reticle such that a significant portion of said generated radiation reflects off of said reticle back through said pellicle toward said wafer.

19. The method of claim 18, further comprising, after irradiating said wafer, removing said wafer and positioning another wafer under said pellicle and performing the steps recited in claim 18 on said another wafer.

20. The method of claim 18, wherein said pellicle further comprises a low-absorption layer of material having an extinction coefficient of at most about 0.02 in the EUV spectral region of about 6-20 nm, wherein at least one of said multiple layers of said at least one single atomic-plane material is formed on said low-absorption layer of material.

21. The method of claim 18, wherein said at least one single atomic-plane material is comprised of at least one of graphene, hexagonal boron nitride, molybdenum sulphide (MoS₂), molybdenum selenide (MoSe₂), molybdenum telluride (MoTe₂), tungsten sulphide (WS₂), tantalum selenide (TaSe₂), niobium selenide (NbSe₂), nickel telluride (NiTe₂), and bismuth telluride (Bi₂Te₃).

22. The method of claim 18, wherein said pellicle is comprised of only multiple layers of graphene.

23. The method of claim 18, wherein said pellicle is comprised of only multiple layers of hexagonal boron nitride.

24. The method of claim 18, wherein said pellicle is comprised of multiple layers of graphene and multiple layers of hexagonal boron nitride.

25. The method of claim 18, wherein said pellicle is comprised of multiple layers of materials selected from the following materials: graphene, hexagonal boron nitride, molybdenum sulphide (MoS₂), molybdenum selenide (MoSe₂), molybdenum telluride (MoTe₂), tungsten sulphide (WS₂), tantalum selenide (TaSe₂), niobium selenide (NbSe₂), nickel telluride (NiTe₂), and bismuth telluride (Bi₂Te₃).

26. The method of claim 18, wherein said pellicle is comprised of a low-absorption layer of material having an extinction coefficient of at most about 0.02 in the EUV spectral region of about 6-20 nm and multiple layers of single atomic-plane material, wherein at least first and second layers of said multiple layers of single atomic-plane material are positioned on opposite sides of said low-absorption layer of material.

27. The method of claim 18, wherein said pellicle is comprised of a low-absorption layer of material having an extinction coefficient of at most about 0.02 in the EUV spectral region of about 6-20 nm, said low-absorption layer of material being positioned between multiple layers of a first single atomic-plane material and multiple layers of a second single atomic-plane material.

28. A method, comprising:
positioning a pellicle between a reticle and a semiconducting substrate, wherein said pellicle is comprised of multiple layers of at least one of graphene or hexagonal boron nitride;
generating radiation at a wavelength of about 20 nm or less; and
directing said generated radiation through said pellicle toward said reticle such that a significant portion of said generated radiation reflects off of said reticle back through said pellicle toward said wafer.

29. The method of claim 28, further comprising, after irradiating said wafer, removing said wafer and positioning another wafer under said pellicle and performing the steps recited in claim 28 on said another wafer.

30. The method of claim 28, wherein said pellicle further comprises a low-absorption layer of material having an extinction coefficient of at most about 0.02 in the EUV spectral region of about 6-20 nm, wherein at least one of said multiple layers is formed on said low-absorption layer of material.

31. The method of claim 28, wherein said pellicle is comprised of only multiple layers of grahene.

32. The method of claim 28, wherein said pellicle is comprised of only multiple layers of hexagonal boron nitride.

33. The method of claim 28, wherein said pellicle is comprised of multiple layers of graphene and multiple layers of hexagonal boron nitride.

34. The method of claim 28, wherein said pellicle is comprised of a low-absorption layer of material having an extinction coefficient of at most about 0.02 in the EUV spectral region of about 6-20 nm and multiple layers of graphene, wherein at least first and second layers of said multiple layers of graphene are positioned on opposite sides of said low-absorption layer of material.

35. The method of claim 28, wherein said pellicle is comprised of a low-absorption layer of material having an extinction coefficient of at most about 0.02 in the EUV spectral region of about 6-20 nm and multiple layers of hexagonal boron nitride, wherein at least first and second layers of said multiple layers of hexagonal boron nitride are positioned on opposite sides of said low-absorption layer of material.

36. The method of claim 28, wherein said pellicle is comprised of a low-absorption layer of material having an extinction coefficient of at most about 0.02 in the EUV spectral region of about 6-20 nm, said low-absorption layer of material being positioned between multiple layers of graphene and multiple layers of hexagonal boron nitride.
